(19) United States
(12) Patent Application Publication
(10) Pub. No.: US 2015/0330615 A1
(43) Pub. Date: Nov. 19, 2015

(54) OPTICAL SEMICONDUCTOR ILLUMINATING APPARATUS

(71) Applicant: Posco LED Company Ltd., Yongin-si (KR)

(72) Inventors: Jung Hwa Kim, Yongin-si (KR); Dae Won Kim, Yongin-si (KR); Jae Young Choi, Yongin-si (KR); Jin Jong Kim, Yongin-si (KR)

(21) Appl. No.: 14/710,783

(22) Filed: May 13, 2015

(30) Foreign Application Priority Data
May 15, 2014 (KR) 10-2014-0058238
Jun. 10, 2014 (KR) 10-2014-0070156
Aug. 4, 2014 (KR) 10-2014-0099593

(51) Int. Cl. F21V 23/00; F21V 29/70

(52) U.S. Cl. CPC F21V 23/002; F21V 29/70; F21Y 2105/001

(57) ABSTRACT

An optical semiconductor illuminating apparatus including a base having a heat sink formed therebelow, a light emitting module including a board disposed on the base and at least one or more semiconductor optical elements arrayed on the board, a board hole penetrating through the board and having wirings penetrating therethrough, the wirings being electrically connected to the semiconductor optical elements, and a wiring protecting part formed in the board hole and protruding from an upper surface of the board at a predetermined height.

### CROSS-REFERENCE TO RELATED APPLICATIONS

This application claims priority from and the benefit of Korean Patent Application No. 10-2014-0058238, filed on May 15, 2014, Korean Patent Application No. 10-2014-0070156, filed on Jun. 10, 2014, and Korean Patent Application No. 10-2014-0099593, filed on Aug. 4, 2014, which are hereby incorporated by reference for all purposes as if fully set forth herein.

### BACKGROUND

1. Field

The present invention relates to an optical semiconductor illuminating apparatus.

2. Discussion of the Background

An optical semiconductor such as a light emitting diode (LED), a laser diode (LD), or the like, is one of components that have recently been widely prominent for illumination due to lower power consumption, a longer lifespan, more excellent durability, and a much higher luminance as compared with an incandescent lamp and a fluorescent lamp.

As an illuminating apparatus based on the optical semiconductor described above, bulb type illuminating apparatuses in which a housing including a heat sink, and the like, is coupled to a socket base having the same shape as that of a halogen lamp or an incandescent lamp, an optical semiconductor is arrayed as a light source in the housing, and an optical member enclosing the optical semiconductor is mounted in the housing have been released.

However, the bulb type illuminating apparatuses have a problem that wirings electrically connected to a board on which the optical semiconductor is mounted through the socket base are deformed and short-circuited while being twisted in a fastening process.

That is, in a product having a type in which a power supply such as a switching mode power supply (SMPS) is embedded in the housing among the bulb type illuminating apparatuses described above, a lower portion of the SMPS may be connected to the socket base through the wirings. In this case, a problem that the wirings are twisted and short-circuited in a process of rotating the socket base to fasten the socket base to the housing may occur.

Here, in a product having a type in which a board on which various circuits such as a driving circuit, a power supplying circuit, and the like, are arrayed, instead of the SMPS, is embedded in the housing among the bulb type illuminating apparatuses described above, the board and the socket base may be connected to each other by the wirings. In this case, a problem that the wirings are twisted and short-circuited in a process of rotating the socket base to fasten the socket base to the housing may occur.

Here, the wirings connected to the board penetrate through a connection hole perforated in the board or a base of the housing in which the board is seated. However, since upper and lower edges of the connection hole are sharp, a fatal problem that coatings of the wirings are stripped due to friction with the upper and lower edges of the connection hole in the above-mentioned fastening process may occur particularly in a metal printed circuit board (MPCB).

Meanwhile, since the bulb type illuminating apparatus based on the optical semiconductor requires a countermeasure against heat generation from the optical semiconductor serving as a light source, a heat sink in which a plurality of fins are formed has been generally manufactured by a method such as a die-casting method, or the like.

However, since this general heat sink is manufactured as described above, a weight of the heat sink itself is heavy, and a cost of the heat sink that becomes a component is also high.

In addition, the heat sink manufactured by the die-casting method has low thermal conductivity, such that heat radiation efficiency against a weight is low.

Therefore, the development of an apparatus capable of being lightened, improving heat radiation efficiency, and promoting electrical stability has been urgently demanded.

### SUMMARY

An object of the present invention is to provide an optical semiconductor illuminating apparatus capable of protecting wirings connected to a board from external impact and preventing the wirings from being twisted and damaged in assembling, fastening, and replacement processes.

Another object of the present invention is to provide an optical semiconductor illuminating apparatus capable of being lightened, improving heat radiation efficiency, and promoting electrical stability.

According to an exemplary embodiment of the present invention, there is provided an optical semiconductor illuminating apparatus including: a base; a heat sink formed below the base; a light emitting module disposed on the base and including at least one or more semiconductor optical elements; a wiring hole having wirings penetrating therethrough and formed in the base, the wirings being electrically connected to the light emitting module; and an accommodating groove extended from an edge of an upper end portion of the wiring hole and depressed from an upper surface of the base, wherein the edge of the upper end portion of the wiring hole is formed to be round.

According to another exemplary embodiment of the present invention, there is provided an optical semiconductor illuminating apparatus including: a base having a heat sink formed therebelow; a light emitting module including a board disposed on the base and at least one or more semiconductor optical elements arrayed on the board; a board hole penetrating through the board and having wirings penetrating therethrough, the wirings being electrically connected to the semiconductor optical elements; and a wiring protecting part formed in the board hole and protruding from an upper surface of the board at a predetermined height.

According to still another exemplary embodiment of the present invention, there is provided an optical semiconductor illuminating apparatus including: a light emitting module having semiconductor optical elements arrayed on an upper surface thereof and including a base plate made of a metal; a casing including a lower end portion at which a socket base is disposed and an upper end portion at which the light emitting module is disposed, having a diameter that becomes large from the lower end portion toward the upper end portion, made of an insulator, and being hollow; a heat sink embedded in the casing, disposed below the light emitting module, being hollow, and made of a non-insulator; and an optical member coupled to the upper end portion of the casing to enclose the base plate and the heat sink from the outside and made of a transparent or translucent synthetic resin, wherein the heat sink has an outer surface closely adhering to an inner surface of the casing.

### BRIEF DESCRIPTION OF THE DRAWINGS

FIG. 1 is a partially exploded perspective view illustrating a structure in which a base and a light emitting module, which are main parts of an optical semiconductor illuminating apparatus according to an exemplary embodiment of the present invention, are connected to each other by wirings;

FIG. 2 is a partially cross-sectional view illustrating the structure in which the base and the light emitting module, which are the main parts of the optical semiconductor illuminating apparatus according to the exemplary embodiment of the present invention, are connected to each other by the wirings;

FIGS. 3 to 5 are partially cross-sectional views illustrating various examples of a wiring hole and an accommodating groove, which are main parts of the present invention, taken along line A-A′ of FIG. 1;

FIGS. 6 and 7 are plan views illustrating various examples of the wiring hole and the accommodating groove, which are the main parts of the present invention, viewed from point B of FIG. 1;

FIG. 8 is a perspective view illustrating an entire configuration of the optical semiconductor illuminating apparatus according to the exemplary embodiment of the present invention;

FIGS. 9 to 16 are conceptual views illustrating a structure in which a wiring protecting part, which is a main part of an optical semiconductor illuminating apparatus according to various exemplary embodiments of the present invention, is coupled to a board hole of a light emitting module;

FIG. 17 is a cross-sectional view illustrating the entire configuration of the optical semiconductor illuminating apparatus according to the exemplary embodiment of the present invention;

FIG. 18 is a plan view viewed from point A of FIG. 17; and

FIG. 19 is a cross-sectional view taken along line B-B′ of FIG. 17.

### DETAILED DESCRIPTION OF THE ILLUSTRATED EMBODIMENTS

Advantages and features of the present invention and methods accomplishing them will become apparent from exemplary embodiments described below in detail with reference to the accompanying drawings.

However, the present invention is not limited to exemplary embodiments herein, but may be implemented in other forms.

On the contrary, exemplary embodiments introduced herein are provided to make disclosed contents thorough and complete and sufficiently transfer the spirit of the present invention to those skilled in the art.

In the accompanying drawings, thicknesses of layers and regions are exaggerated for the purpose of clearness.

Terms such as an upper end and a lower end, an upper surface and a lower surface, or an upper portion and a lower portion are used in order to distinguish relative positions of components from each other.

For example, in the case in which an upper side on the accompanying drawing is called an upper portion and a lower side on the accompanying drawing is called a lower portion for convenience, the upper portion may be called a lower portion and the lower portion may be called an upper portion without departing from the scope of the present invention.

Terms used in the present specification are used only in order to describe specific exemplary embodiments rather than limiting the present invention.

Singular forms are intended to include plural forms unless the context clearly indicates otherwise.

It will be understood that the terms “comprises” or “have” used in this specification, specify the presence of stated features, numerals, steps, operations, components, parts mentioned in this specification, or a combination thereof, but do not preclude the presence or addition of one or more other features, numerals, steps, operations, components, parts, or a combination thereof.

Unless indicated otherwise, it is to be understood that all the terms used in the specification including technical and scientific terms have the same meaning as those that are generally understood by those who skilled in the art.

It must be understood that the terms defined by the dictionary are identical with the meanings within the context of the related art, and they should not be ideally or excessively formally defined unless the context clearly dictates otherwise.

Hereinafter, exemplary embodiments of the present invention will be described in detail with reference to the accompanying drawings.

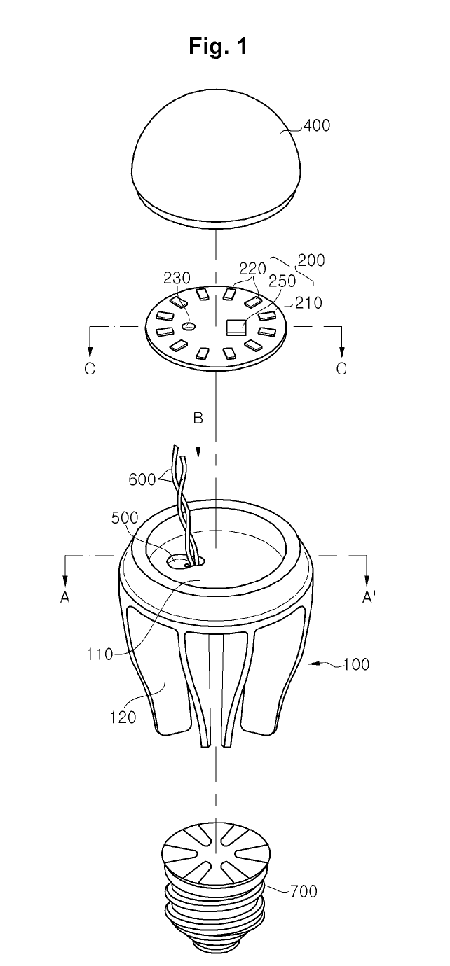

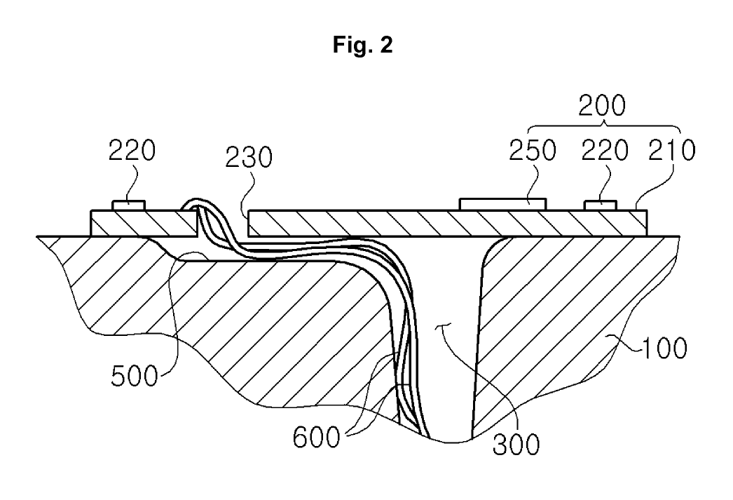

FIG. 1 is a partially exploded perspective view illustrating a structure in which a base and a light emitting module, which are main parts of an optical semiconductor illuminating apparatus according to an exemplary embodiment of the present invention, are connected to each other by wirings; and FIG. 2 is a partially cross-sectional view illustrating the structure in which the base and the light emitting module, which are the main parts of the optical semiconductor illuminating apparatus according to the exemplary embodiment of the present invention, are connected to each other by the wirings.

For reference, a reference numeral 400, which is not described, indicates an optical member.

The optical semiconductor illuminating apparatus according to the exemplary embodiment of the present invention may be configured to include a housing 100 including a base 110 and a heat sink 120, a light emitting module 200, a wiring hole 300, and an accommodating groove 500, as illustrated in FIGS. 1 and 2.

The housing 100 includes the base 110 and the heat sink 120 formed below the base 110.

The base 110 provides an area in which a light emitting module 200 to be described below is disposed, and the heat sink 120 is to solve a heat generation problem of the light emitting module 200.

The light emitting module 200, which is disposed on the base 110 and includes at least one semiconductor optical elements 220, includes the semiconductor optical element 220, a driving integrated chip (IC) 250, and the like, arrayed on a board 210, wherein the semiconductor optical element 220 is driven as alternating current (AC) by the driving IC 250 to serve as a light source.

The wiring hole 300 through which wirings 600 electrically connected to the light emitting module 200 penetrates is formed in the base 110 and is to provide a path in which the wirings 600 are disposed.

The accommodating groove 500 is extended from an edge of an upper end portion of the wiring hole 300 and is depressed from an upper surface of the base 110.

Here, it is preferable that the edge of the upper end portion of the wiring hole 300 is formed to be round.

Here, the edge of the upper end portion of the wiring hole 300 is formed to be round in order to prevent coatings of the wirings 600 from being stripped due to external impact such as friction, or the like.

Therefore, the wirings 600 are exposed through the wiring hole 300, are bent, and are pressed by a load of the light emitting module 200 to thereby be accommodated in the accommodating groove 500, such that separation of the wirings 600 may be prevented, as illustrated in FIG. 2.

In the present invention, the exemplary embodiment as described above may be applied, and various exemplary embodiments to be described below may also be applied.

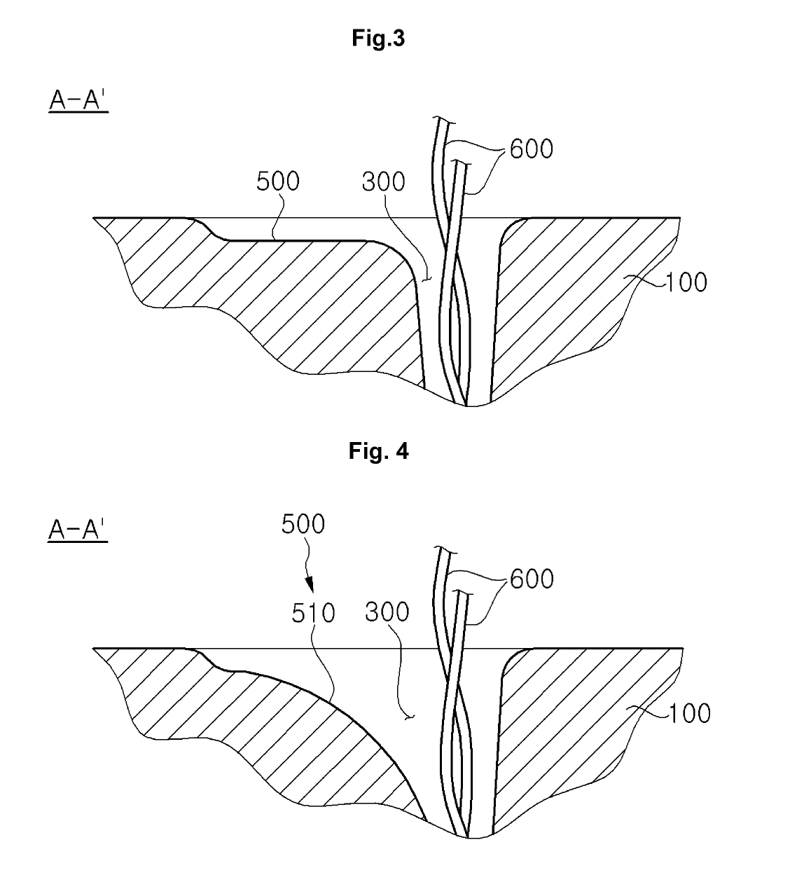

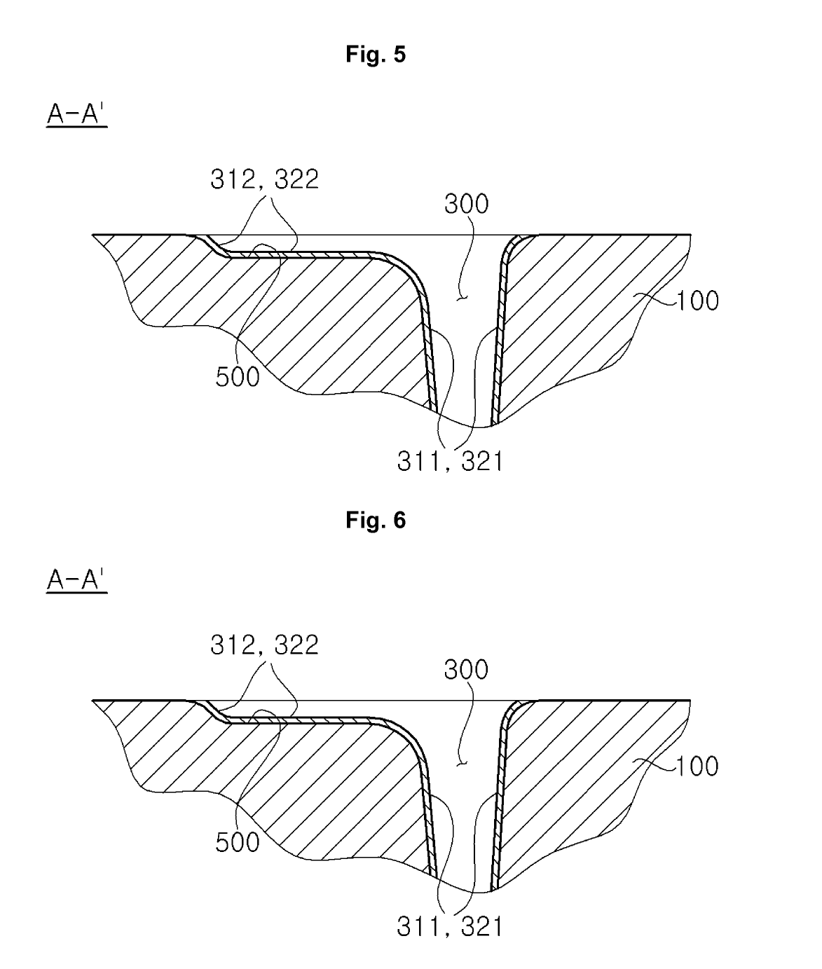

It is preferable that an edge of an upper end portion of the accommodating groove 500 is formed to be round in order to protect the wirings 600 and smoothly mount the light emitting module 200 on the base 110, as illustrated in FIGS. 3 to 5.

Here, in the present invention, it is preferable that a first wiring protecting coating layer 311 is further formed or a first wiring protecting member 321 is further mounted on an inner peripheral surface of the wiring hole 300 and in the vicinity of the edge of the upper end portion of the wiring hole 300 in order to protect the wirings 600.

Here, in the present invention, it is preferable that a second wiring protecting coating layer 312 is further formed or a second wiring protecting member 322 is further mounted in the accommodating groove 500 in order to protect the wirings 600.

In addition, the accommodating groove 500 further includes an inclined surface 510 formed to be downwardly inclined toward the wiring hole 300. This inclined surface 510 has a linear or arc cross-sectional shape, thereby enabling protection and efficient disposition of the wirings 600.

Meanwhile, a socket base 700 may rotate in one direction to thereby be mounted in the heat sink 120, and the wirings 600 are electrically connected to the light emitting module 200 in a state in which they are twisted in an opposite direction to the rotation direction of the socket base 700.

The reason is that a problem that the wirings 600 are twisted and short-circuited at the time of rotating the socket base 700 to fasten the socket base 700 to the heat sink 120 occurs in the case in which the wirings 600 are not twisted in the opposite direction to the rotation direction of the socket base 700 at the time of fastening the socket base 700 to the heat sink 120, since the optical semiconductor illuminating apparatus according to the exemplary embodiment of the present invention is an illuminating apparatus having a type in which the light emitting module 200 and the socket base 700 are directly connected to each other by the wirings 600 unlike an existing illuminating apparatus in which a component such as a switching mode power supply (SMPS), a circuit board, or the like, is embedded in the housing, that is, the heat sink 120.

Therefore, in the present invention, the wirings 600 are twisted in the opposite direction to the rotation direction of the socket base 700 at the time of fastening the socket base 700 to the heat sink 120, thereby making it possible to prevent short-circuit, damage, or the like, of the wirings 600 due to deformation of the wirings 600 in assembling and fastening processes.

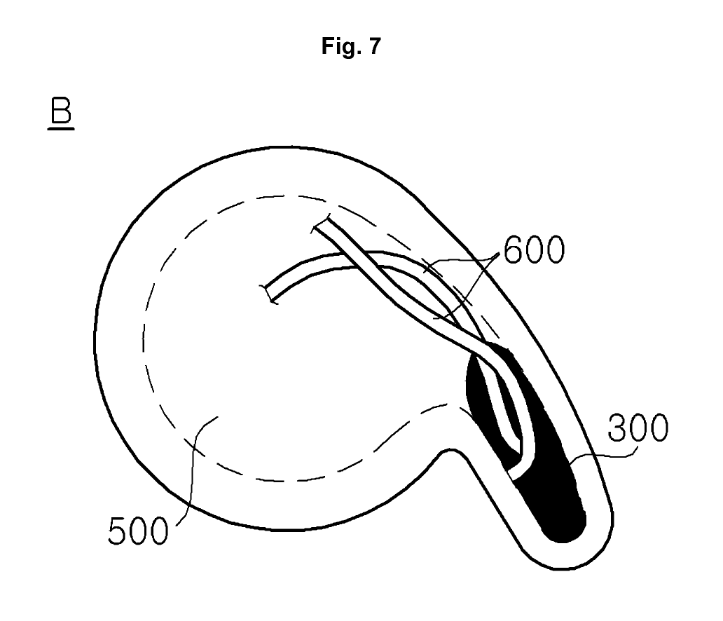

Meanwhile, it is preferable that a central portion of the accommodating groove 500 is disposed to be biased toward one side with respect to a central portion of the wiring hole 300 as illustrated in more detail in FIGS. 6 and 7 so that the wirings 600 may be exposed through the wiring hole 300, be bent, and be pressed by the load of the light emitting module 200 to thereby be accommodated in the accommodating groove 500, as illustrated in the cross-sectional view of FIG. 2.

That is, the wiring hole 300 may be extended from an edge of the accommodating groove 500, the accommodating groove 500 may have a circular or oval shape, as illustrated in FIG. 6, and the wiring hole 300 may be formed in a long hole shape in which it is extended from an edge of a circle or an oval.

In addition, the accommodating groove 500 has a circular or oval shape, as illustrated in FIG. 7, and the wiring hole 300 is extended from an edge of a circle or an oval in a tangential direction of the circle or the oval, such that when the wirings 600 are twisted in the opposite direction of the rotation direction at the time of fastening the light emitting module 200, the short-circuit, the damage, or the like, of the wirings 600 due to the deformation of the wirings 600 may be prevented in the assembling and fastening processes.

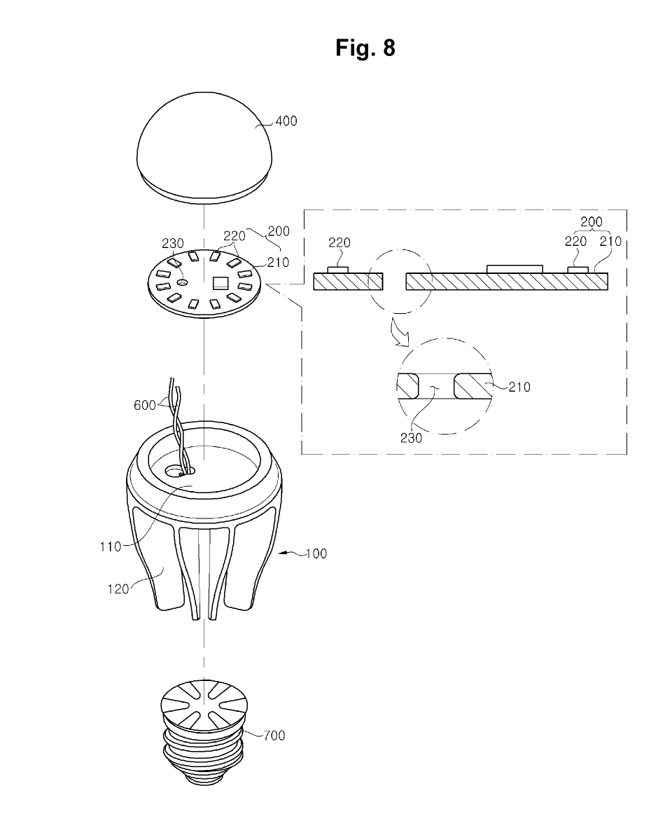

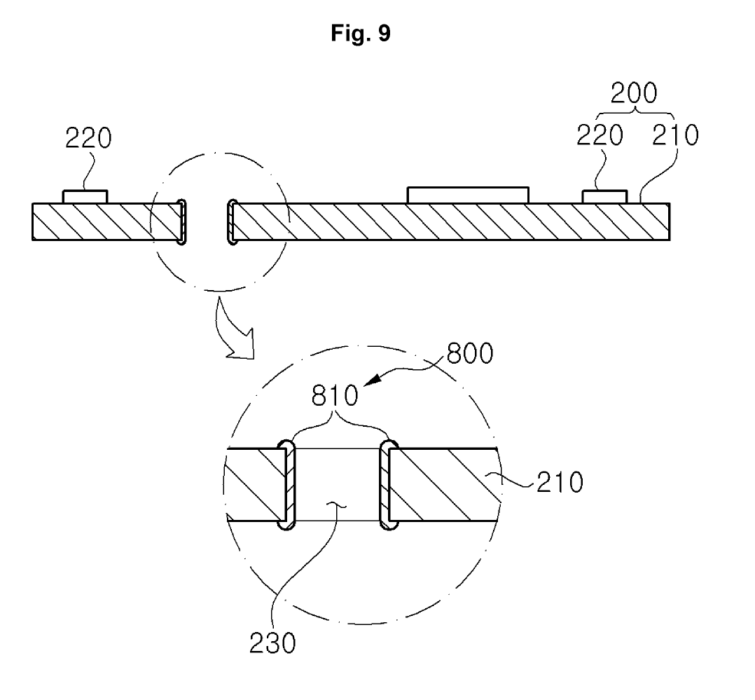

Meanwhile, FIG. 8 is a perspective view illustrating an entire configuration of the optical semiconductor illuminating apparatus according to the exemplary embodiment of the present invention; and FIGS. 9 to 16 are conceptual views illustrating a structure in which a wiring protecting part, which is a main part of an optical semiconductor illuminating apparatus according to various exemplary embodiments of the present invention, is coupled to a board hole of a light emitting module.

The optical semiconductor illuminating apparatus according to the exemplary embodiment of the present invention may have a structure in which the light emitting module 200 is provided in the housing 100, a board hole 230 is formed in the board 210 of the light emitting module 200, and a wiring protecting part 800 is formed in the board hole 230, as illustrated in FIGS. 8 to 16.

For reference, a reference numeral 400, which is not described, indicates an optical member.

The housing 100 includes the base 110 and the heat sink 120 formed below the base 110.

The base 110 provides an area in which a light emitting module 200 to be described below is disposed, and the heat sink 120 is to solve a heat generation problem of the light emitting module 200.

The light emitting module 200 includes the board 210 disposed on the base 110 and at least one or more semiconductor optical elements 220 arrayed on the board 210, wherein the semiconductor optical elements 220 serve as a light source.

The board hole 230 penetrates through the board 210 and provides a path through which the wirings 600 electrically connected to the semiconductor optical elements 220 passes.

The wiring protecting part 800, which is formed in the board hole 230 and protrudes from an upper surface of the board 210 at a predetermined height, is to prevent coatings of the wirings 600 from being stripped or damaged in assembling and fastening processes.

In the present invention, the exemplary embodiment as described above may be applied, and various exemplary embodiments to be described below may also be applied.

In the present invention, an exemplary embodiment in which an edge of an upper end portion and an edge of a lower end portion of the board hole 230 are formed to be round, such that the wiring protecting part 800 is omitted, as illustrated in FIG. 8, may also be applied.

First, it is preferable that portions at which the wiring protecting part 800 and the coatings of the wirings 600 contact each other are formed to be round in order to protect the coatings of the wirings 600 from friction and physical and chemical impact.

In addition, the wiring protecting part 800 may be formed integrally with the board 210 or be formed to be detachable from the board 210, as described in detail below.

To this end, for example, in the case in which the wiring protecting part 800 is formed integrally with the board 210, when it is assumed that the board 210 is a general printed circuit board (PCB), the wiring protecting part 800 in the vicinity of the board hole 230 may be manufactured by double injection molding so as to be formed integrally with the board.

In addition, the wiring protecting part 800 may also be manufactured to be detachable from the board hole 230 by manufacturing, for example, structures according to various exemplary embodiments to be described.

Further, it is preferable that the wiring protecting part 800 is made of an insulating material in order to protect the wirings 600 and prevent electrical impact or electric leakage and electric shock accidents.

In addition, it is preferable that a height at which the wiring protecting part 800 protrudes from the upper surface of the board 210 is lower than or equal to a height at which the semiconductor optical element 220 protrudes from the upper surface of the board 210 in order for the wiring protecting part 800 to protrude at a minimum height so as to minimize formation of a dark band and light loss and certainly protect the coatings of the wirings 600.

Meanwhile, the wiring protecting part 800 is to protect the coatings of the wirings 600, as described above, and an exemplary embodiment in which the wiring protecting part 800 includes a wiring guide 810 enclosing an inner peripheral surface of the board hole 230 and the edge of the upper end portion and the edge of the lower end portion of the board hole 230, as illustrated in FIG. 9, may be applied.

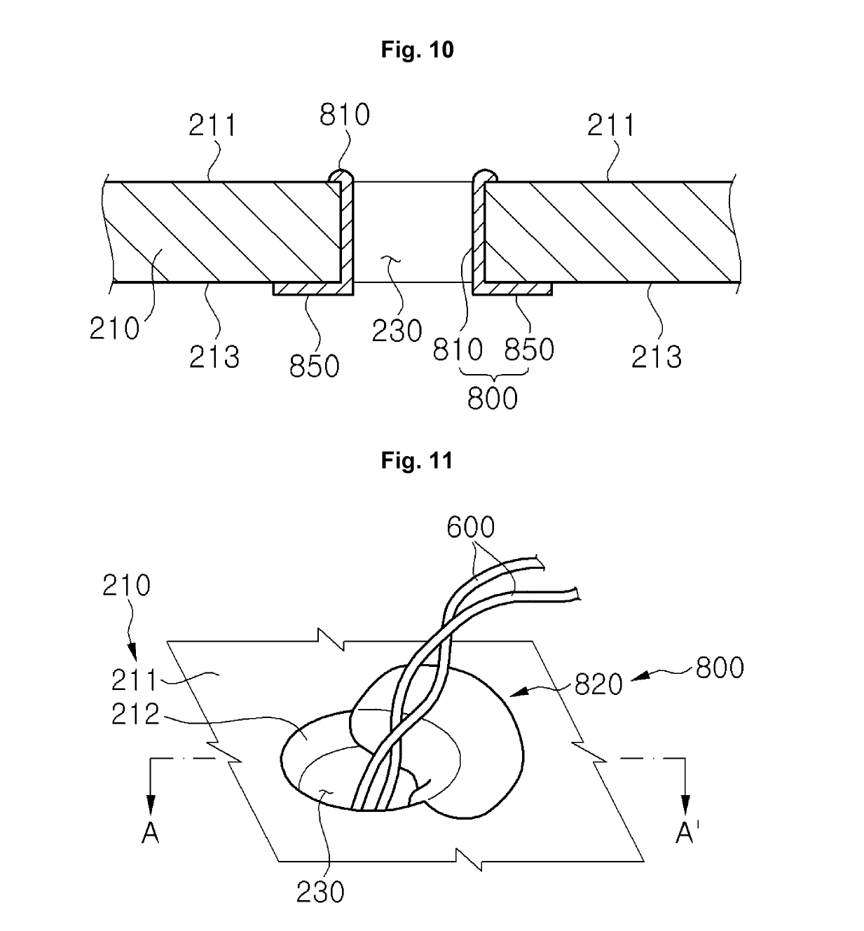

Here, an exemplary embodiment in which a lower portion of the wiring protecting part 800 is fixed to a third surface 213 forming a lower surface of the board 210, as illustrated in FIG. 10, may also be applied.

That is, the wiring protecting part 800 may further include a fixing piece 850 extended from a lower end portion of the wiring guide 810 and fixed to the third surface 213 forming the lower surface of the board 210 in order to more stably maintain a fastening fixing state.

Therefore, an upper end portion of the wiring protecting part 800 is exposed to an upper side of a first surface 211 forming the upper surface of the board 210 on which the semiconductor optical elements 220 are arrayed, thereby making it possible to allow the wirings 600 to be guided by the wiring protecting part 800 to thereby be electrically connected to the board 210 while allowing the wirings 600 to be bent or curved.

Meanwhile, an outer surface of the wiring protecting part 800 may contact a portion or the entirety of a second surface 212 forming an inner peripheral surface of the board hole 230, as illustrated in FIGS. 9 to 16, in some cases.

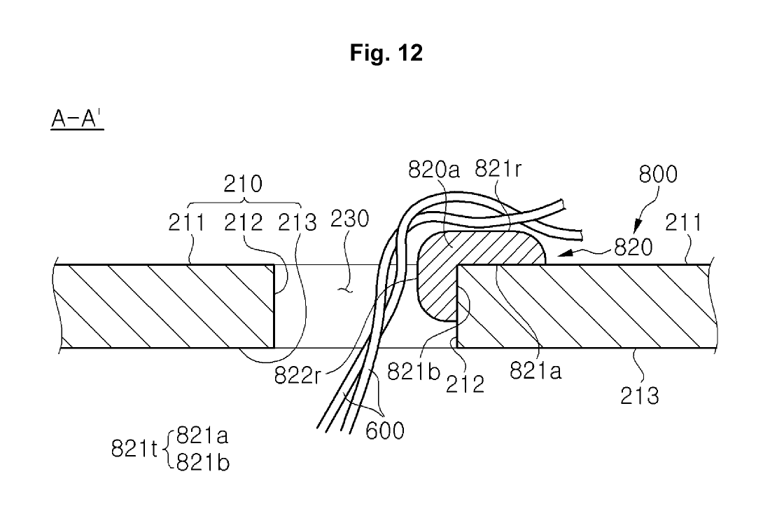

In addition, an exemplary embodiment in which the wiring protecting part 800 includes a protecting piece 820 fixed to a portion of a corner part at which the first surface 211 forming the upper surface of the board 210 and the second surface 212 forming the inner peripheral surface of the board hole 230 meet each other, as illustrated in FIGS. 11 and 12, may be applied.

That is, it is preferable that the protecting piece 820 includes a first body 820a fixed to the board 210 and a first step part 821t including a first seating surface 821a formed on a lower surface of the first body 820a and facing the first surface 211 and a first contact surface 821b facing the second surface 212, so as to be accurately seated on and fixed to the board 210 through the board hole 230.

Here, it is preferable that the protecting piece 820 further includes a first curved surface part 821r formed at an opposite side to the first seating surface 821a so as to be round and a second curved surface part 822r formed at an opposite side of the first contact surface 821b and extended from the first curved surface part 821r so as to be round in order to more certainly protect the coatings of the wirings 600.

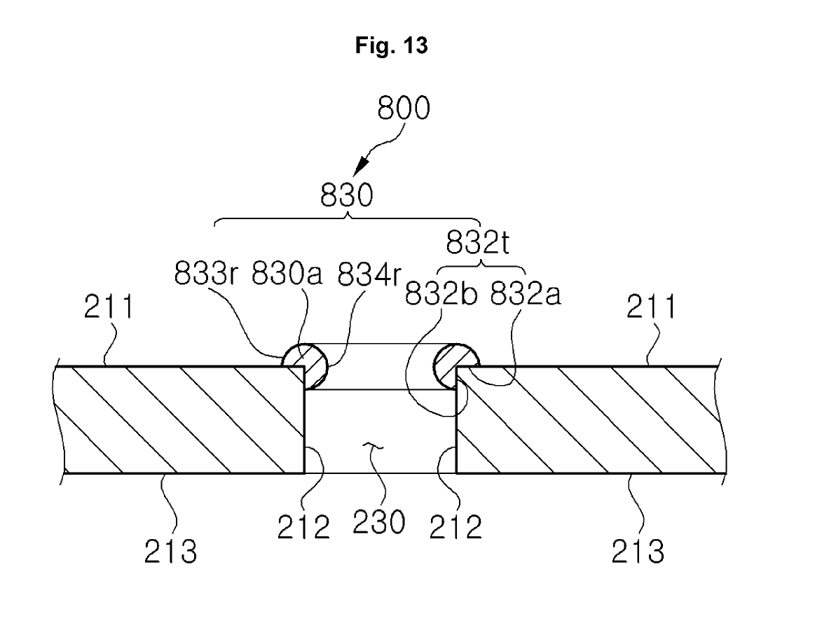

Meanwhile, as the wiring protecting part 800, a structure of the protecting piece 820 fixed to a portion of the board hole 230 as in the exemplary embodiment described above may be applied, and an exemplary embodiment in which the wiring protecting part 800 includes a protecting ring 830 fixed along an edge of the board hole 230, as illustrated in FIG. 13 may also be applied.

That is, the protecting ring 830 is fixed to the entirety of a corner part at which the first surface 211 forming the upper surface of the board 210 and the second surface forming the inner peripheral surface of the board hole 230 meet each other.

Here, it is preferable that the protecting ring 830 includes a second body 830a fixed to the board 210 and a second step part 832t including a second seating surface 832a formed on a lower surface of the second body 830a and facing the first surface 211 and a second contact surface 832b facing the second surface 212, so as to be accurately seated on and fixed to is the board 210 through the board hole 230.

Here, it is preferable that the protecting ring 830 further includes a third curved surface part 833r formed at an opposite side to the second seating surface 832a so as to be round and having a ring shape and a fourth curved surface part 834r formed at an opposite side of the second contact surface 832b, extended from the third curved surface part 833r so as to be round and having a ring shape, in order to more certainly protect the coatings of the wirings 600.

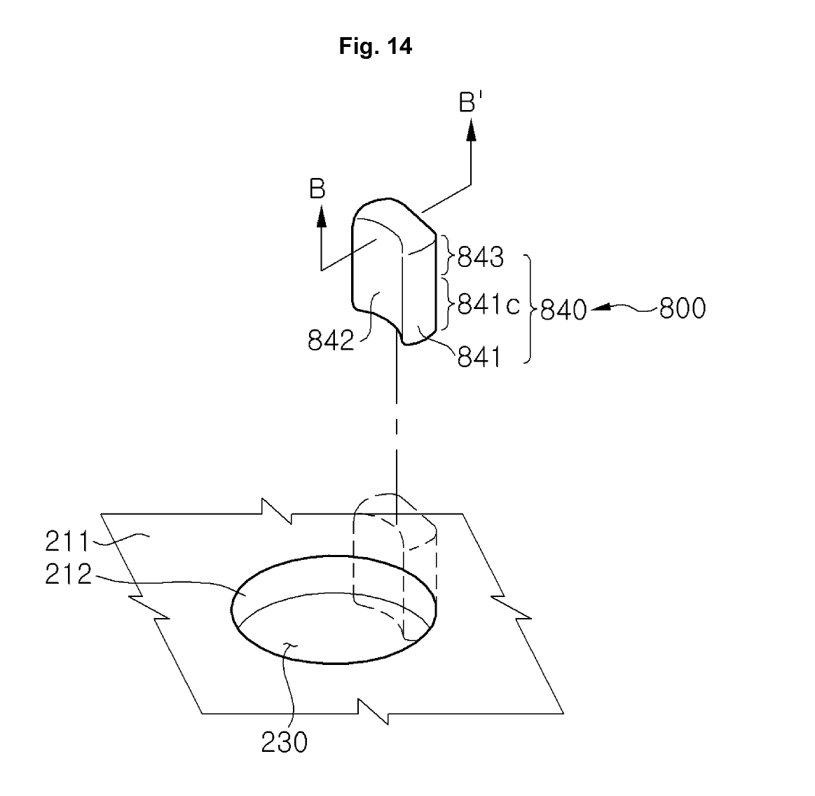

Meanwhile, an exemplary embodiment in which the wiring protecting part 800 includes a protecting saddle piece 840 fixed to the second surface 212 forming the inner peripheral surface of the board hole 230, as illustrated in FIGS. 14 to 16 may be applied.

The protecting saddle piece 840 will be described in detail with reference to FIG. 14. The protecting saddle piece 840 may include a saddle piece body 841 including a third contact surface 841c forming an outer surface fixed to the second surface 212 of the board hole 230 and a guide groove 842 formed at an opposite side of the third contact surface 841c and depressed in a vertical direction of the saddle piece body 841.

Here, the wirings 600 are seated and guided in the guide groove 842.

Here, the protecting saddle piece 840 further includes a cradling part 843 extended from an upper portion of the saddle piece body 841 and protruding to the outside of the board hole 230 so that the wirings 600 may be electrically connected to the board 210 without being hindered in a state in which the wirings 600 are allowed to be bent or curved, and an outer surface of the cradling part 843 may be extended from the third contact surface 841c.

In addition, it is preferable that the guide groove 842 is extended up to an upper end portion of the cradling part 843 on an inner surface of the cradling part 843 and a corner part at which an upper surface of the cradling part 843 and an end portion of the guide groove 842 meet each other is formed to be round so that the wirings 600 may be electrically connected to the board 210 without being hindered in the state in which the wirings 600 are allowed to be bent or curved.

Therefore, the wirings 600 are bent through the corner part at which the upper surface of the cradling part 843 and the end portion of the guide groove 842 meet each other and which is formed to be round and are electrically connected to the semiconductor optical elements 220 of the board 210, various driving circuits, and the like.

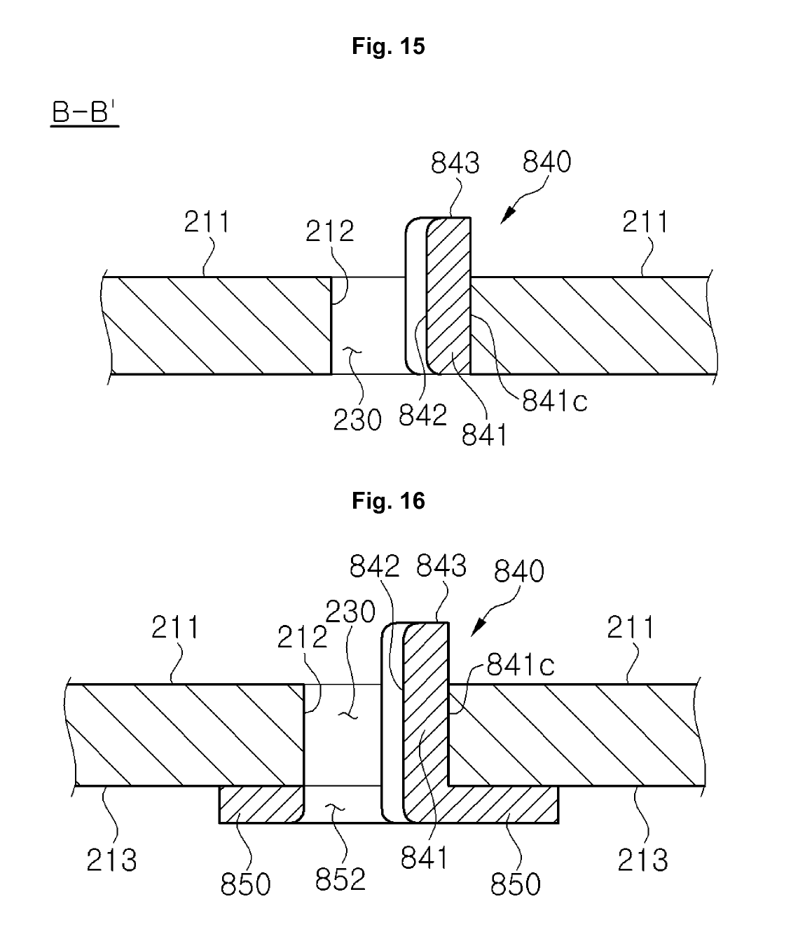

In addition, a corner part at which a lower surface of the saddle piece body 841 and the end portion of the guide groove 842 meet each other is formed to be round, as illustrated in FIG. 15, thereby making it possible to prevent the coatings of the wirings 600 from being stripped or damaged due to a part that the wirings 600 may contact, as much as possible.

In addition, an exemplary embodiment in which the wiring protecting part 800 includes the fixing piece 850 extended from a lower surface of the protecting saddle piece 840 and contacting the third surface 213 forming the lower surface of the board 210 so that the protecting saddle piece 840 may be more certainly fixed to the board 210, as illustrated in FIG. 16, may also be applied.

Here, the guide groove 842 is extended up to an edge of the fixing piece 850, a corner part at which an upper surface of the cradling part 843 and an end portion of the guide groove 842 meet each other is formed to be round, and a corner part at which a lower surface of the saddle piece body 841 and an end portion of the guide groove 842 meet each other is formed to be round, thereby making it possible to protect the coatings of the wirings 600 as much as possible.

Here, the wiring protecting part 800 may further include a communication hole 852 penetrating through the fixing piece 850, connected to the board hole 230, and having the wirings 600 penetrating therethrough, and the protecting saddle piece 840 may be formed at an edge of the communication hole 852.

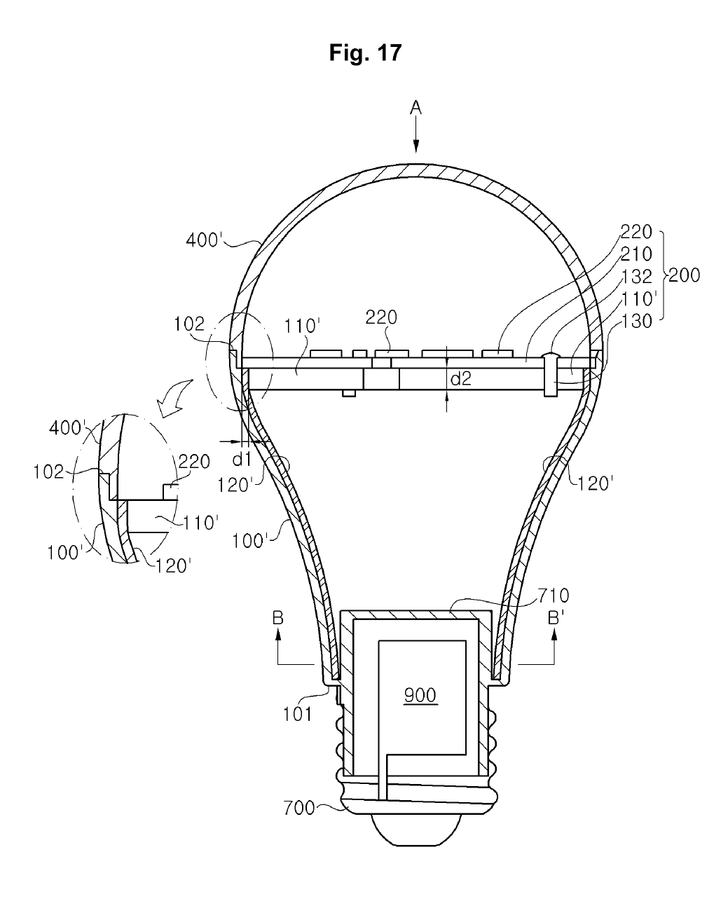

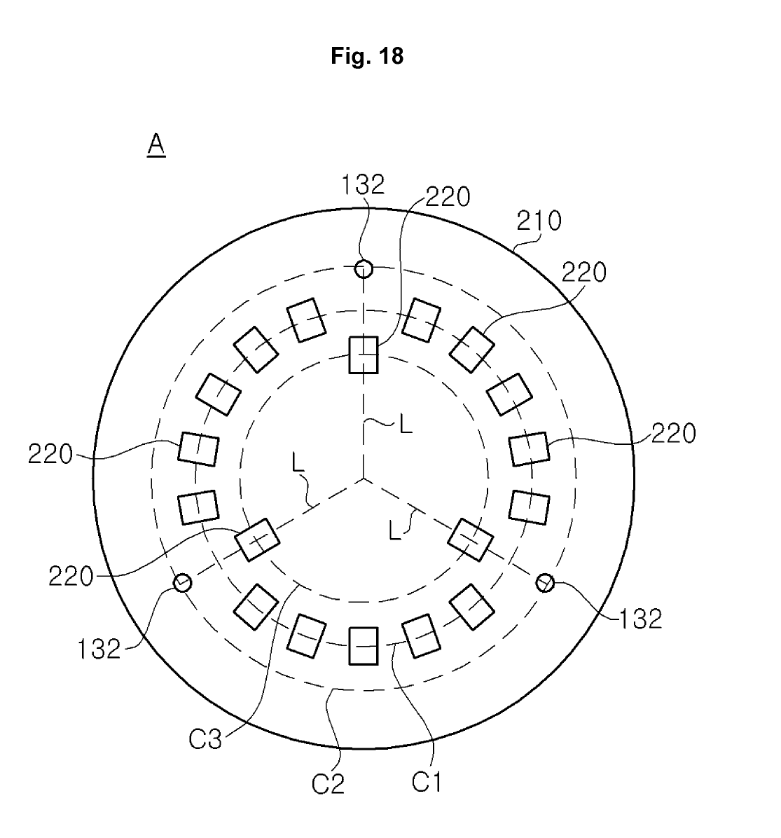

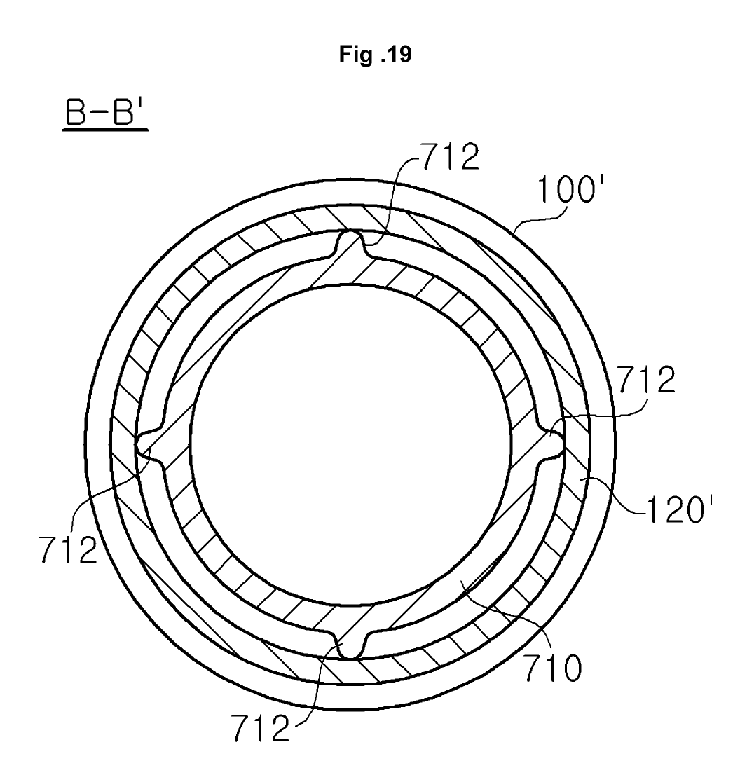

Meanwhile, FIG. 17 is a cross-sectional view illustrating the entire configuration of the optical semiconductor illuminating apparatus according to the exemplary embodiment of the present invention; FIG. 18 is a plan view viewed from point A of FIG. 17; and FIG. 19 is a cross-sectional view taken along line B-B′ of FIG. 17.

The optical semiconductor illuminating apparatus according to the exemplary embodiment of the present invention may be configured to include a light emitting module 200, a hollow casing 100′, a heat sink 120′ made of a metal, and an optical member 400′, as illustrated in FIGS. 17 to 19.

The light emitting module 200 has semiconductor optical elements 220 arrayed on an upper surface thereof, and includes a base plate 110′ made of a metal.

The casing 100′ is a hollow member including a lower end portion 101 at which a socket base 700 is disposed and an upper end portion 102 at which the light emitting module 200 is disposed, having a diameter that becomes large from the lower end portion 101 toward the upper end portion 102, and made of a synthetic resin.

The heat sink 120′ is a hollow member embedded in the casing 100′, disposed below the light emitting module 200, having an outer peripheral surface closely adhering to an inner peripheral surface of the casing 100′, and made of a metal.

Here, the casing 100′ serves as an insulator accommodating the heat sink 120′, which is a non-insulator, therein and protecting the light emitting module 200 from a surge.

The optical member 400′ is coupled to the upper end portion 102 of the casing 100′ to enclose the base plate 110′ and the heat sink 120′ from the outside and is made of a transparent or translucent synthetic resin.

Therefore, since the optical semiconductor illuminating apparatus according to the exemplary embodiment of the present invention has a form in which an outer surface of the heat sink 120′, which is the hollow member made of the metal, closely adheres and fixes to an inner surface of the casing 110′, which is the hollow member made of the synthetic resin, it is possible to maximize heat radiation efficiency while structurally implementing lightness of the entire illuminating apparatus.

In addition, in the optical semiconductor illuminating apparatus according to the exemplary embodiment of the present invention, since the light emitting module 200 including the base plate 110′ made of the metal and the heat sink 120′ are not exposed to the outside by the casing 100′ and the optical member 400′ that are made of the synthetic resin, surge protection and withstand voltage prevention are possible, thereby making it possible to promote electrical stability.

In the present invention, the exemplary embodiment as described above may be applied, and various exemplary embodiments to be described below may also be applied.

It is preferable that the heat sink 120′ is made of a metal thin plate having a first thickness d1 and the base plate 110′ has a second thickness d2 thicker than the first thickness d1.

That is, the base plate 110′ is manufactured to be thicker than the heat sink 120′ to increase a heating area, thereby making it possible to improve heat radiation efficiency.

Here, an upper surface of the base plate 110′ is disposed at a position lower than or equal to an edge of the upper end portion 102 of the casing 100′ to allow members such as the heat sink 120′, the base plate 110′, and the like, that are made of the metal not to be exposed to the outside without hindering the upper end portion 102 of the casing 100′ from being fastened to the optical member 400′, such that the surge protection and the withstand voltage prevention as described above are possible, thereby making it possible to promote the electrical stability.

Here, an outer peripheral surface of an edge of the base plate 110′ may be press-fitted into an inner peripheral surface of the upper end portion 102 of the heat sink 120′.

This is due to a feature in a shape of the heat sink 120′ closely adhering and fixing to the casing 100′ so as to correspond to an entire shape of the casing 100′.

Here, it is preferable that the casing 100′ is made of a synthetic resin having excellent durability, heat resistance, chemical resistance, and the like. For example, the casing 100′ may also be made of a material such as polybutylene-terephthalate (PBT), or the like.

Meanwhile, an exemplary embodiment in which the optical semiconductor illuminating apparatus further includes a board 210 disposed on the base plate 110′ and having a plurality of semiconductor optical elements 220 radially arrayed thereon and a plurality of fixtures 130 such as bolts, or the like, fixing the board 210 to the base plate 110′ may also be applied.

Here, it is preferable that heads 132 of the plurality of fixtures 130 exposed on the board 210 are mold-processed using a synthetic resin in order to satisfy surge protection and the withstand voltage specifications.

Here, in the present invention, as illustrated in FIG. 18, an array of the semiconductor optical elements 220 may be slightly changed depending on fixing disposition positions of the heads 132.

First, in the present invention, first to third virtual circles C1 to C3 and virtual lines L may be defined.

The first virtual circle C1 is formed by connecting the centers of the plurality of semiconductor optical elements 220 radially disposed on the board 210 to each other.

In addition, the second virtual circle C2 is formed by connecting the centers of the heads 132 of the plurality of fixtures 130 exposed on the board 210 to each other.

Further, the virtual lines L are formed by connecting the center of the board 210 to the centers of the heads 132.

Therefore, one of the plurality of semiconductor optical elements 220 is disposed on each of the virtual lines L, and the semiconductor optical elements 220 disposed on the virtual lines L are disposed at an inner side of the first virtual circle C1.

This disposition is to satisfy the surge protection and the withstand voltage specifications in the vicinity of the heads 132 of the fixtures 130 made of a metal.

Here, the third virtual circle C3 formed by connecting the centers of the semiconductor optical elements 220 disposed on the virtual lines L to each other may be further defined together with the first and second virtual circles C1 and C2 and the virtual lines L defined above.

It may be appreciated that a diameter of the second virtual circle C2 is larger than that of the first virtual circle C1 and a diameter of the third virtual circle C3 is smaller than that of the first virtual circle C1.

In addition, in the present invention, it is preferable that distances from semiconductor optical elements 220 disposed at left and right sides of the virtual lines L among the plurality of semiconductor optical elements 220 disposed on the first virtual circles C1 to the centers of the heads 132 are the same as each other so as to obtain a uniform light distribution.

That is, since various problems such as damage to a circuit, and the like, due to a withstand voltage may occur in the vicinity of the heads 132 of the fixtures 130 such as the bolts, or the like, the semiconductor optical elements 220 are disposed on the board 210 on which the heads 132 are disposed to be spaced apart from the heads 132 by predetermined distances, as illustrated in FIG. 18, thereby making it possible to protect components including the semiconductor optical elements 220 from the surge and the withstand voltage.

Meanwhile, an exemplary embodiment in which the optical semiconductor illuminating apparatus further includes a protecting box part 710 protruding from an inner side of the lower end portion 101 of the casing 100′, electrically connected to the socket base 700, and accommodating an SMPS or a surge protecting circuit 900 therein may also be applied.

In addition, the protecting box part 710 is formed to become gradually narrow toward an upper side of the casing 100′ so that an edge of a lower end portion of the heat sink 120′ is smoothly inserted and is seated and fixed into the casing 100′, thereby making it possible to guide the insertion of the lower end portion of the heat sink 120′.

In addition, the optical semiconductor illuminating apparatus according to the exemplary embodiment of the present invention may further include a heat sink fixing part provided on the protecting box part 710 and fixing the lower end portion of the heat sink 120′ between the casing 100′ and the protecting box part 710, as illustrated in FIG. 19.

That is, it may be appreciated that the heat sink fixing part includes a plurality of fixing ribs 712 protruding from an outer surface of the protecting box part 710 toward the inner peripheral surface of the casing 100′ in the vertical direction of the protecting box part 710.

It is preferable that a distance from the fixing ribs 712 to the inner peripheral surface of the casing 100′ is smaller than or equal to the first thickness d1 (See FIG. 17) of the heat sink 120′ made of the metal thin plate so that the heat sink 120′ may be firmly fixed in a press-fitting scheme.

As described above, it may be appreciated that a basic technical spirit of the present invention is to provide the optical semiconductor illuminating apparatus capable of protecting the wirings connected to the board from the external impact, preventing the wirings from being twisted and damaged at assembling, fastening, and replacement processes, being lightened, improving the heat radiation efficiency, and promoting the electrical stability.

According to the exemplary embodiments of the present invention having the configuration as described above, the following effects may be accomplished.

First, according to the exemplary embodiment of the present invention, since the wirings electrically connected to the light emitting module are bent through the edge of the upper end portion of the wiring hole formed to be round and are pressed by the light emitting module to thereby be accommodated in the accommodating groove extended from the edge of the upper end portion of the wiring hole, separation of the wirings due to external force may be prevented.

In addition, according to the exemplary embodiment of the present invention, the wirings penetrating through the wiring hole are electrically connected to the light emitting module in the state in which they are twisted at least once, and are twisted in the opposite direction to the rotation direction of the socket base at the time of fastening the socket base to the heat sink, thereby making it possible to prevent the short-circuit, the damage, or the like, of the wirings due to the deformation of the wirings in the assembling and fastening processes.

Further, the optical semiconductor illuminating apparatus according to the exemplary embodiment of the present invention includes various types of wiring protecting parts provided in the board hole penetrating through the board of the light emitting module, thereby making it possible to prevent the coatings of the wirings from being stripped or damaged in the assembling and fastening processes.

Furthermore, the optical semiconductor illuminating apparatus according to the exemplary embodiment of the present invention includes the heat sink having the outer surface closely adhering and fixing to the inner surface of the casing made of the synthetic resin and being hollow, made of the metal, and being hollow, thereby making it possible to maximize the heat radiation efficiency while implementing the lightness of the entire illuminating apparatus.

Moreover, according to the exemplary embodiment of the present invention, the light emitting module including the base plate made of the metal and the heat sink are not exposed to the outside by the casing and the optical member that are made of the synthetic resin, such that the surge protection and the withstand voltage prevention are possible, thereby making it possible to promote the electrical stability.

In addition, various modifications and applications may also be made by those skilled in the art without departing from the scope of the basic technical spirit of the present invention.

What is claimed is:

1. An optical semiconductor illuminating apparatus comprising:
a base having a heat sink formed therebelow;
a light emitting module including a board disposed on the base and at least one or more semiconductor optical elements arrayed on the board;
a board hole penetrating through the board and having wirings penetrating therethrough, the wirings being electrically connected to the semiconductor optical elements; and
a wiring protecting part formed in the board hole and protruding from an upper surface of the board at a predetermined height.

2. The optical semiconductor illuminating apparatus of claim 1, wherein portions at which the wiring protecting part and coating of the wirings contact each other are formed to be round.

3. The optical semiconductor illuminating apparatus of claim 1, wherein the wiring protecting part is formed integrally with the board.

4. The optical semiconductor illuminating apparatus of claim 1, wherein the wiring protecting part is detachable from the board.

5. The optical semiconductor illuminating apparatus of claim 1, wherein the wiring protecting part is made of an insulating material.

6. The optical semiconductor illuminating apparatus of claim 1, wherein a height at which the wiring protecting part protrudes from the upper surface of the board is lower than or equal to a height at which the semiconductor optical element protrudes from the upper surface of the board.

7. The optical semiconductor illuminating apparatus of claim 1, wherein an edge of an upper end portion and an edge of a lower end portion of the board hole are formed to be round.

8. The optical semiconductor illuminating apparatus of claim 1, wherein the wiring protecting part includes a wiring guide enclosing an inner peripheral surface of the board hole and an edge of an upper end portion and an edge of a lower end portion of the board hole.

9. The optical semiconductor illuminating apparatus of claim 8, wherein the wiring protecting part further includes a fixing piece extended from a lower end portion of the wiring guide and fixed to a third surface forming a lower surface of the board.

10. The optical semiconductor illuminating apparatus of claim 1, wherein an upper end portion of the wiring protecting part is exposed to an upper side of a first surface forming the upper surface of the board on which the semiconductor optical elements are arrayed.

11. The optical semiconductor illuminating apparatus of claim 1, wherein an outer surface of the wiring protecting part contacts a portion or the entirety of a second surface forming an inner peripheral surface of the board hole.

12. The optical semiconductor illuminating apparatus of claim 1, wherein a lower portion of the wiring protecting part is fixed to a third surface forming a lower surface of the board.

13. The optical semiconductor illuminating apparatus of claim 1, wherein the wiring protecting part includes a protecting piece fixed to a portion of a corner part at which a first surface forming the upper surface of the board and a second surface forming an inner peripheral surface of the board hole meet each other.

14. The optical semiconductor illuminating apparatus of claim 1, wherein the wiring protecting part includes a protecting ring fixed to the entirety of a corner part at which a first surface forming the upper surface of the board and a second surface forming an inner peripheral surface of the board hole meet each other.

15. The optical semiconductor illuminating apparatus of claim 1, wherein the wiring protecting part includes a protecting saddle piece fixed to a second surface forming an inner peripheral surface of the board hole.

16. The optical semiconductor illuminating apparatus of claim 15, wherein the protecting saddle piece includes:
a saddle piece body including a third contact surface forming an outer surface fixed to the second surface of the board hole; and
a guide groove formed at an opposite side of the third contact surface and depressed in a vertical direction of the saddle piece body.

17. The optical semiconductor illuminating apparatus of claim 16, wherein the protecting saddle piece further includes a cradling part extended from an upper portion of the saddle piece body and protruding to the outside of the board hole, and
an outer surface of the cradling part is extended from the third contact surface.

18. The optical semiconductor illuminating apparatus of claim 16, wherein the protecting saddle piece further includes a cradling part extended from an upper portion of the saddle piece body and protruding to the outside of the board hole, and
the guide groove is extended up to an upper end portion of the cradling part on an inner surface of the cradling part.

19. The optical semiconductor illuminating apparatus of claim 18, wherein a corner part at which an upper surface of the cradling part and an end portion of the guide groove meet each other is formed to be round.

20. The optical semiconductor illuminating apparatus of claim 16, wherein a corner part at which a lower surface of the saddle piece body and an end portion of the guide groove meet each other is formed to be round.

21. The optical semiconductor illuminating apparatus of claim 1, wherein the wiring protecting part includes:
a protecting saddle piece fixed to a second surface forming an inner peripheral surface of the board hole; and
a fixing piece extended from a lower surface of the protecting saddle piece and contacting a third surface forming a lower surface of the board.
